(19) United States
(12) Patent Application Publication
(10) Pub. No.: US 2026/0023584 A1
(43) Pub. Date: Jan. 22, 2026

(54) MICROSERVICES DEPLOYMENTS USING MACHINE LEARNING

(71) Applicant: Dell Products L.P., Round Rock, TX (US)

(72) Inventors: David J. Linsey, Marietta, GA (US); Bijan Kumar Mohanty, Austin, TX (US); Hung Dinh, Austin, TX (US)

(21) Appl. No.: 18/774,416

(22) Filed: Jul. 16, 2024

(51) Int. Cl. G06F 9/455; G06N 3/08

(52) U.S. Cl. CPC G06F 9/45558; G06N 3/08; G06F 2009/4557

(57) ABSTRACT

A method comprises receiving a request for cloud deployment of at least one microservice, wherein the request includes one or more features of the at least one microservice. The one or more features are analyzed using one or more machine learning algorithms. The method further comprises predicting, based at least in part on the analyzing: (i) a cloud platform of a plurality of cloud platforms to deploy the at least one microservice; and (ii) a cloud instance in which the at least one microservice is to be executed, and interfacing with the cloud platform to enable deployment of the at least one microservice.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The field relates generally to information processing systems, and more particularly to cloud provider deployments in information processing systems.

### BACKGROUND

Cloud-based software deployments permit software developers to build and run applications without having to manage underlying hardware and associated foundational software, such as operating systems. However, software developers are still required to select cloud providers and the virtual environments in which applications may run. The number of virtual instance options offered by various cloud providers is extremely large. Moreover, due to numerous differences between cloud offerings, and given an increased number of microservices being deployed on virtualized platforms, cloud provider and virtual environment selection for microservices has become increasingly complex. In some cases, a given cloud provider may not satisfy all of the requirements for microservice implementation, and due to a lack of standardization between cloud provider platform configurations, switching to or adding additional cloud providers may be problematic.

### SUMMARY

Embodiments provide a microservices deployment platform in an information processing system.

For example, in one embodiment, a method comprises receiving a request for cloud deployment of at least one microservice, wherein the request includes one or more features of the at least one microservice. The one or more features are analyzed using one or more machine learning algorithms. The method further comprises predicting, based at least in part on the analyzing: (i) a cloud platform of a plurality of cloud platforms to deploy the at least one microservice; and (ii) a cloud instance in which the at least one microservice is to be executed, and interfacing with the cloud platform to enable deployment of the at least one microservice.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 depicts an information processing system with a microservices deployment platform, according to an illustrative embodiment.

FIG. 2 depicts an operational flow for cloud deployment of microservices, according to an illustrative embodiment.

FIG. 3 depicts example pseudocode for generation of a hash digest of files corresponding to a cloud deployment of a microservice, according to an illustrative embodiment.

FIG. 4 depicts sample training data for training machine learning algorithms to predict a plurality of first targets and a plurality of second targets for a microservice, according to an illustrative embodiment.

FIG. 5 depicts an operational flow for prediction of a cloud provider, a cloud instance and a cloud instance configuration, according to an illustrative embodiment.

FIG. 6A depicts example pseudocode for importation of libraries, according to an illustrative embodiment.

FIG. 6B depicts example pseudocode for loading historical microservice data into a data frame, according to an illustrative embodiment.

FIG. 7 depicts example pseudocode for encoding a dataset for machine learning, according to an illustrative embodiment.

FIG. 8 depicts example pseudocode for normalizing and reducing dimensionality of a dataset, according to an illustrative embodiment.

FIG. 9 depicts example pseudocode for splitting a dataset into training and testing components and for creating separate datasets for independent and dependent variables, according to an illustrative embodiment.

FIG. 10A depicts example pseudocode for using a designated library to build a neural network, according to an illustrative embodiment.

FIG. 10B depicts example pseudocode for building a cloud provider branch of a neural network, according to an illustrative embodiment.

FIG. 10C depicts example pseudocode for building a host type (cloud instance type) branch of a neural network, according to an illustrative embodiment.

FIG. 10D depicts example pseudocode for building a compute utilization branch of a neural network, according to an illustrative embodiment.

FIG. 10E depicts example pseudocode for building a memory utilization branch of a neural network, according to an illustrative embodiment.

FIG. 10F depicts example pseudocode for building an input-output value branch of a neural network, according to an illustrative embodiment.

FIG. 10G depicts example pseudocode for building a storage utilization branch of a neural network, according to an illustrative embodiment.

FIG. 10H depicts example pseudocode for assembling a neural network and setting a loss function, metrics and an optimizer of a neural network, according to an illustrative embodiment.

FIG. 11A depicts example pseudocode for training a neural network model, according to an illustrative embodiment.

FIG. 11B depicts example pseudocode for computing loss of a neural network model, according to an illustrative embodiment.

FIG. 11C depicts example pseudocode for computing predictions with a neural network model, according to an illustrative embodiment.

FIG. 12 depicts an operational diagram corresponding to operation of the cloud provider deployment and monitoring engine, according to an illustrative embodiment.

FIGS. 13A and 13B depict example pseudocode for deploying a microservice as a serverless function in a first cloud provider platform, according to an illustrative embodiment.

FIG. 14 depicts example pseudocode for deploying a microservice as a serverless function in a second cloud provider platform, according to an illustrative embodiment.

FIGS. 15A and 15B depict example pseudocode for retrieving microservice metrics from a first cloud provider platform, according to an illustrative embodiment.

FIGS. 16A and 16B depict example pseudocode for retrieving microservice metrics from a second cloud provider platform, according to an illustrative embodiment.

FIGS. 17A and 17B depict example pseudocode for retrieving microservice metrics from a third cloud provider platform, according to an illustrative embodiment.

FIG. 18 depicts a process for cloud deployment of microservices, according to an illustrative embodiment.

FIGS. 19 and 20 show examples of processing platforms that may be utilized to implement at least a portion of an information processing system, according to illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Such systems are considered examples of what are more generally referred to herein as cloud-based computing environments. Some cloud infrastructures are within the exclusive control and management of a given enterprise, and therefore are considered “private clouds.” The term “enterprise” as used herein is intended to be broadly construed, and may comprise, for example, one or more businesses, one or more corporations or any other one or more entities, groups, or organizations. An “entity” as illustratively used herein may be a person or system. On the other hand, cloud infrastructures that are used by multiple enterprises, and not necessarily controlled or managed by any of the multiple enterprises but rather respectively controlled and managed by third-party cloud providers, are typically considered “public clouds.” Enterprises can choose to host their applications or services on private clouds, public clouds, and/or a combination of private and public clouds (hybrid clouds) with a vast array of computing resources attached to or otherwise a part of the infrastructure. Numerous other types of enterprise computing and storage systems are also encompassed by the term “information processing system” as that term is broadly used herein.

As used herein, “real-time” refers to output within strict time constraints. Real-time output can be understood to be instantaneous or on the order of milliseconds or microseconds. Real-time output can occur when the connections with a network are continuous and a requesting device receives messages without any significant time delay. Of course, it should be understood that depending on the particular temporal nature of the system in which an embodiment is implemented, other appropriate timescales that provide at least contemporaneous performance and output can be achieved.

As used herein, “application programming interface (API)” refers to a set of subroutine definitions, protocols, and/or tools for building software. Generally, an API defines communication between software components. APIs permit programmers to write software applications consistent with an operating environment or website. APIs are used to integrate and pass data between applications, and may be implemented on top of other systems.

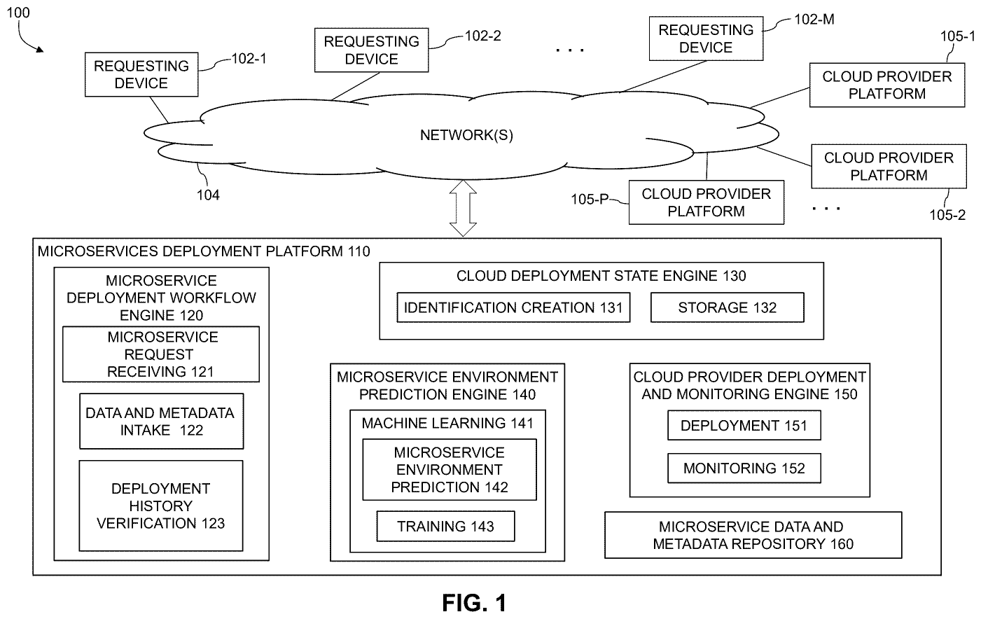

FIG. 1 shows an information processing system 100 configured in accordance with an illustrative embodiment. The information processing system 100 comprises requesting devices 102-1, 102-2, . . . 102-M (collectively “requesting devices 102”) and cloud provider platforms 105-1, 105-2, . . . 105-P (collectively “cloud provider platforms 105”). The requesting devices 102 and cloud provider platforms 105 communicate over a network 104 with a microservices deployment platform 110. The variable M and other similar index variables herein such as K, L, S and P are assumed to be arbitrary positive integers greater than or equal to one.

The requesting devices 102 and one or more devices of the cloud provider platforms 105 can comprise, for example, Internet of Things (IoT) devices, server, desktop, laptop or tablet computers, mobile telephones, or other types of processing devices capable of communicating with the microservices deployment platform 110 over the network 104. Such devices are examples of what are more generally referred to herein as “processing devices.” Some of these processing devices are also generally referred to herein as “computers.” The requesting devices 102 and one or more devices of the cloud provider platforms 105 may also or alternately comprise virtualized computing resources, such as virtual machines (VMs), containers, etc. The requesting devices 102 and/or one or more devices of the cloud provider platforms 105 in some embodiments comprise respective computers associated with a particular company, organization or other enterprise.

The terms “customer,” “administrator,” “personnel” or “user” herein are intended to be broadly construed so as to encompass numerous arrangements of human, hardware, software or firmware entities, as well as combinations of such entities. Cloud deployment services may be provided for users utilizing one or more machine learning models, although it is to be appreciated that other types of infrastructure arrangements could be used. At least a portion of the available services and functionalities provided by the microservices deployment platform 110 in some embodiments may be provided under Function-as-a-Service (“FaaS”), Containers-as-a-Service (“CaaS”) and/or Platform-as-a-Service (“PaaS”) models, including cloud-based FaaS, CaaS and PaaS environments.

Although not explicitly shown in FIG. 1, one or more input-output devices such as keyboards, displays or other types of input-output devices may be used to support one or more user interfaces to the microservices deployment platform 110, as well as to support communication between the microservices deployment platform 110 and connected devices (e.g., requesting devices 102 and one or more devices of the cloud provider platforms 105) and/or other related systems and devices not explicitly shown.

In some embodiments, the requesting devices 102 are assumed to be associated with repair technicians, system administrators, information technology (IT) managers, software developers, release management personnel or other authorized personnel configured to access and utilize the microservices deployment platform 110. The requesting devices 102 can also be respectively associated with one or more customers requiring the services of one or more cloud providers. Some non-limiting examples of cloud providers that may correspond to the cloud provider platforms 105 include, but are not necessarily limited to, Amazon® Web Services (AWS®), Azure®, Google® Cloud Platform (GCP®) and/or Dell® Apex® cloud providers.

As noted hereinabove, due to a large number of virtual instance options offered by various cloud providers, numerous differences between cloud offerings, and an increased number of microservices being deployed on virtualized platforms, cloud provider and virtual environment selection for microservices has become increasingly complex. For example, cloud-native development with microservices is emerging as a crucial strategy enabling the rapid delivery of new products and services. The modern developer is faced with a litany of different virtualized deployment options such as, for example, Infrastructure-as-a-Service (IaaS), Platform-as-a-Service (PaaS), Functions-as-a-Service (FaaS), Bare metal-as-a-service (BMaaS), and Container-as-a-Service (CaaS). Each of these options may have their own advantages and disadvantages, specific constraints and unique variations. Not every piece of software can seamlessly function on each type of virtualized environment. For example, performing raw disk input-output (I/O) operations, which must be shared across deployments will likely limit deployments to IaaS and PaaS options, which have accessible shared storage.

Developers may know in advance what types of methodologies they want (or are allowed) to use, but are typically unfamiliar with constraints that may be specific to each methodology. What may work fine in a local development environment (such as system disk I/O operations) may cause challenges when attempting to package and deploy such operations in a production environment. Additionally, developers may not understand which deployment strategies are best for their specific modules. For example, code may run well in a FaaS environment, but a developer may choose a PaaS-based deployment due to factors such as comfort and/or familiarity with the PaaS environment. In addition, whether to deploy a microservice on a virtual machine (VM), container, bare metal host and/or in a serverless model can be a complex decision. For example, microservices that require strong isolation or require extensive resources might be best for VM deployment, whereas stateless applications that require rapid scaling might be suitable for containerized deployment. Microservices that require high performance and security may be best suited for bare metal deployments.

In order to address the problems with current approaches, illustrative embodiments provide technical solutions which use machine learning to intelligently recommend optimum cloud providers for different microservices and cloud instances in which to deploy the microservices. For example, depending on the functions being performed by a microservice, the microservice may require different types of cloud providers and instance types. The embodiments advantageously provide a microservices deployment framework that permits intelligent selection of cloud providers and cloud instances based on a variety of features associated with microservices. Leveraging machine learning-based multi-target classification and regression models, the framework predicts optimal cloud providers and deployment environments for microservices based on historical microservices deployments data corresponding to multiple features of the microservices. In addition, embodiments advantageously utilize a multi-cloud interface layer that can abstract the complexities of application programming interfaces (APIs) and other interfaces to different cloud providers for provisioning a predicted deployment configuration. This end-to-end multi-cloud deployment framework for microservices enables intelligent automation of microservices deployment in a multi-cloud environment.

The microservices deployment platform 110 in the present embodiment is assumed to be accessible to the requesting devices 102 and/or cloud provider platforms 105 and vice versa over the network 104. The network 104 is assumed to comprise a portion of a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks. The network 104 in some embodiments therefore comprises combinations of multiple different types of networks each comprising processing devices configured to communicate using Internet Protocol (IP) or other related communication protocols.

As a more particular example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

Referring to FIG. 1, the microservices deployment platform 110 includes a microservice) deployment workflow engine 120, a cloud deployment state engine 130, a microservice environment prediction engine 140, a cloud provider deployment and monitoring engine 150 and a microservice data and metadata repository 160. The microservice deployment workflow engine 120 includes a microservice request receiving layer 121, a data and metadata intake layer 122 and a deployment history verification layer 123. The cloud deployment state engine 130 includes an identification creation layer 131 and a storage layer 132. The microservice environment prediction engine 140 includes a machine learning layer 141 comprising microservice environment prediction layer 142 and training layer 143. The cloud provider deployment and monitoring engine 150 includes a deployment layer 151 and a monitoring layer 152.

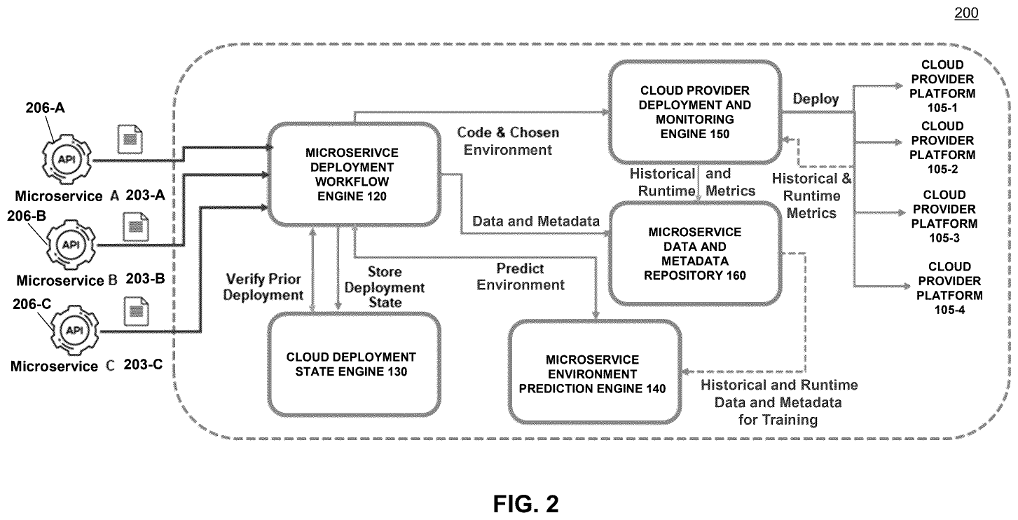

The microservice request receiving layer 121 of the microservice deployment workflow engine 120 receives microservice deployment requests from one or more requesting devices 102. Referring to the operational flow 200 of FIG. 2, in a non-limiting illustrative embodiment, the microservice deployment workflow engine 120 (e.g., microservice request receiving layer 121) receives requests from applications running on the requesting devices 102. For example, the microservice deployment requests may be initiated from applications running on the requesting devices 102 for microservice A 203-A, microservice B 203-B and microservice C 203-C (collectively “microservices 203”) and comprise application programming interface (API) calls using one or more APIs (e.g., API 206-A, API 206-B and API 206-C (collectively “APIs 206”). In some embodiments, the requests may be automated or initiated by one or more users of the requesting devices 102. As explained in more detail herein, the microservice deployment workflow engine 120 identifies cloud providers, cloud instances and cloud instance configurations for microservices to be run in a cloud environment by invoking a request to the microservice environment prediction engine 140 to predict a cloud provider, cloud instance and cloud instance configuration for a given microservice. The microservice environment prediction engine 140 leverages machine learning to predict an optimal cloud provider, cloud instance and cloud instance configuration for the given microservice.

The data and metadata intake layer 122 collects and processes data and metadata received in a request for deployment of a microservice. The data and metadata for a microservice to be deployed may be included with microservice deployment request from one or more requesting devices 102, and can be collected from, for example, the microservice request receiving layer 121. The data and metadata for a microservice to be deployed is sent to and stored in the microservice data and metadata repository 160. The data and metadata for a microservice to be deployed comprise, for example, one or more features identifying at least one of a size of code for the microservice, a language of the code for the microservice, a complexity tier of the microservice, an interactivity determination of the microservice (yes or no depending on if the function is intended to be used in an interactive manner), a cold start time of the microservice, an execution time of the microservice, and a memory consumption of the microservice. In illustrative embodiments, a complexity tier of a microservice is based on cyclomatic, dependency and/or integration complexity as returned by code coverage tools such as, for example, SonarQube®, etc. Cold start time and execution time may be, for example, average or median times. One or more of the features can be in the form of data in addition to or as an alternative metadata.

In more detail, in illustrative embodiments, cyclomatic complexity measures, for example, the number of linearly independent paths through code. For a given application, the embodiments account for code loops, branches and connected components, of which all can have an effect on virtual CPU (vCPU) demand. In connection with coding language, the embodiments consider code language(s) (e.g., JAVA, JSON, Python, etc.) used for a given application and a percentage of the number of lines of code corresponding to each development language. Different languages can have different resource overhead, especially when comparing interpreted, ahead-of-time (AOT) compiled, and just-in-time (JIT) compiled languages.

Referring to FIGS. 1 and 2, in connection with the cloud deployment state engine 130, the deployment history verification layer 123 of the microservice deployment workflow engine 120 verifies a deployment history of a microservice that is the subject of a request for deployment. In illustrative embodiments, the verification comprises determining whether a given microservice was previously deployed on a particular cloud platform (e.g., AWS, Azure, GCP, etc.) and in a particular cloud instance type (e.g., VM, container, bare metal host, etc.). If the given microservice was previously deployed on the particular cloud platform using the particular cloud instance, the verification further comprises determining whether code for the microservice specified in a request is unchanged from the previous deployment. In more detail, in an illustrative embodiment, the deployment history verification layer 123 verifies the previous deployment history of a microservice by invoking a call to the cloud deployment state engine 130. If the microservice was deployed in the past on a cloud provider platform 105 using a given cloud instance, and no changes to the microservice code were made since the previous deployment, the call to the cloud deployment state engine 130 is returned as true, and the microservice deployment workflow engine 120 will not continue with the deployment.

If a response from the cloud deployment state engine 130 indicates that a given microservice was not previously deployed, the microservice deployment workflow engine 120 invokes a request to the microservice environment prediction engine 140, which leverages machine learning to predict an optimized cloud provider platform 105, cloud instance type and cloud instance configuration to deploy the microservice. The microservice deployment workflow engine 120 sends the microservice code and data identifying the predicted cloud provider platform 105, cloud instance type and cloud instance configuration to the cloud provider deployment and monitoring engine 150, which is configured to interface with the predicted cloud provider platform 105 to cause deployment of the microservice by the predicted cloud provider platform 105.

The cloud deployment state engine 130 maintains data corresponding to deployment states of microservices by respective cloud provider platforms 105 and cloud instance types. This data management helps prevent duplicate deployments if multiple deployment requests for the same microservice are received. The identification creation layer 131 of the cloud deployment state engine 130 generates a unique identifier for the deployment of a given microservice. In illustrative embodiments, the generating of the unique identifier comprises using a hash function to generate a hash digest of one or more files corresponding to the deployment of the microservice. The generated hash digest is stored in a storage layer 132 of the cloud deployment state engine 130. In illustrative embodiments, the storage layer 132 comprises a persistent cache, but the embodiments are not necessarily limited thereto. Upon receiving a request to verify a past deployment of a function, the cloud deployment state engine 130 searches the storage layer 132 with a function identifier (e.g., hash value) and returns a result based on whether a previous deployment (e.g., hash digest) is found.

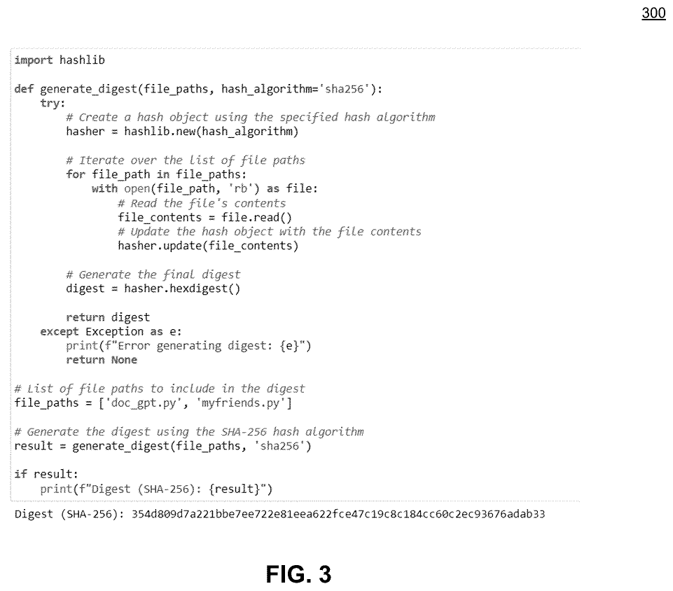

In some embodiments, the hash digest is created using an SHA-256 algorithm, which can be available in a Python library. In the case of multiple files as part of a package of deployments, a zip file or a Java archive (JAR) file can be created and passed to a hashlib library for creating the digest. FIG. 3 depicts example pseudocode 300 for generation of a hash digest of files corresponding to a cloud deployment of a microservice. The pseudocode 300 includes Python code for creating a hash of multiple files.

When a microservice with a code package is deployed by a cloud provider platform 105, the unique hash digest along with results of the deployment (e.g., non-error and error situations) is cached in the storage layer 132 for the future searches and reference. Additional metadata including the deployment cloud provider platform (e.g., AWS® platform, Azure® platform, GCP®) platform, etc.) and time taken for the deployment are captured for analytics and additional training of the machine learning algorithms used by the microservice environment prediction engine 140 for future predictions. The additional metadata can also be cached in the storage layer 132.

The cloud provider deployment and monitoring engine 150 collects historical deployment and runtime data and metadata for microservices from the cloud provider platforms 105. The collected deployment and runtime data and metadata is sent to and stored in the microservice data and metadata repository 160. The historical deployment and runtime data and metadata comprises, for example, respective ones of a plurality of microservices associated with at least one of: (i) a code size; (ii) a code language; (iii) a complexity tier; (iv) an interactivity determination; (v) a cold start time (e.g., average, median, etc.); and (vi) an execution time (e.g., average, median, etc.). One or more of the features can be in the form of data in addition to or as an alternative metadata.

As explained in more detail herein, historical deployment data and metadata from the microservice data and metadata repository 160 is used by the microservice environment prediction engine 140 to train one or more machine learning models to accurately predict a cloud provider, cloud instance type and a cloud instance configuration for a newly received request for deployment of a microservice on a cloud provider platform 105. In some embodiments, historical deployment data and metadata is used as a first training dataset, and following deployment, runtime metrics data and metadata is used as a second (subsequent) training dataset to fine-tune the one or more machine learning algorithms that have been trained with the first training dataset.

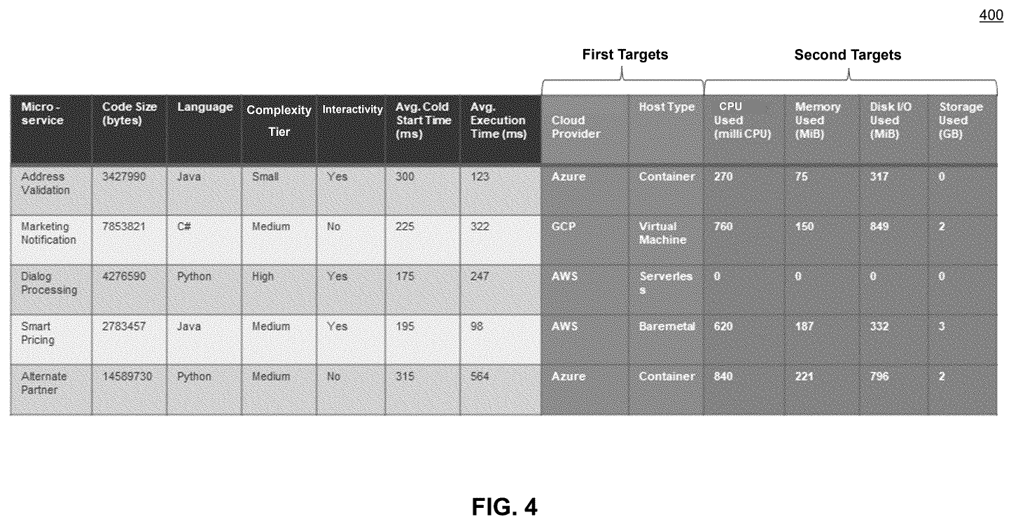

FIG. 4 depicts a table 400 of sample historical deployment data and metadata and/or runtime metrics data and metadata that may be used to train the one or more machine learning models used for cloud provider prediction, cloud instance type (also referred to herein as “host type”), and cloud instance configuration by the microservice environment prediction engine 140. It is to be understood that the data illustrated in table 400 is illustrative, and the embodiments are not necessarily limited to what is shown in FIG. 4. Historical deployment data and metadata and/or runtime metrics data and metadata with more or less features may be used in other embodiments. As can be seen in the table 400, the training data identifies multi-dimensional features. The features include, for example, a microservice name, a code size (e.g., in bytes), a code language (e.g., JAVA, C#, Python), a complexity tier (e.g., small, medium, high), an interactivity determination (yes/no), an average a cold start time (e.g., in milliseconds), and an average execution time (e.g., in milliseconds). The cloud providers and host types (e.g., cloud instances) are identified as first targets in the table 400 and cloud instance configuration parameters (e.g., utilization of, for example, central processing unit (CPU), memory, disk I/O and storage for a cloud instance), are identified as second targets in the table 400. The first targets are target variables that are predicted by the machine learning layer 141 of the microservice environment prediction engine 140 using a classification algorithm, and the second targets are target variables that are predicted by the machine learning layer 141 of the microservice environment prediction engine 140 using a regression algorithm.

The microservice environment prediction engine 140, more particularly, the training layer 143 of the machine learning layer 141 uses the historical deployment data and metadata and/or runtime metrics data and metadata collected by the cloud provider deployment and monitoring engine 150 to train one or more machine learning algorithms used by the microservice environment prediction layer 142 to predict a cloud provider, cloud instance type and cloud instance configuration to deploy a given microservice.

While one or more of the second targets are used for most host types, a serverless model may not use any secondary targets. The illustrative embodiments use a sophisticated multi-target machine learning model to predict all first and second target variables and to address the conditionality of the second targets based on the first target predictions. In an illustrative embodiment, while first and second targets are predicted using the multi-target machine learning model, a post-processing step is implemented to consider the appropriate second targets based on the predicted first targets. For example, CPU, storage and disk I/O utilization predictions may not be useful for serverless model host types and may be omitted if the host type is a serverless model. In another example, disk I/O utilization and network bandwidth (another possible second target not previously mentioned) may be considered relevant for bare metal hosts, while the remaining second types can be omitted.

The microservice environment prediction layer 142 of the microservice environment prediction engine 140 predicts, with a high degree of accuracy, a cloud provider, cloud instance type and cloud instance configuration to deploy a given microservice. The prediction is based, at least in part, on a variety of features used in the training data received from the microservice data and metadata repository 160. Given the complexity of, dimensionality of, and inter-relationships between the variety of features, illustrative embodiments utilize a deep learning approach. Considering this is a case of multi-target prediction, which uses classification techniques to predict the first targets and regression techniques to predict the second targets, the embodiments utilize a deep neural network-based architecture.

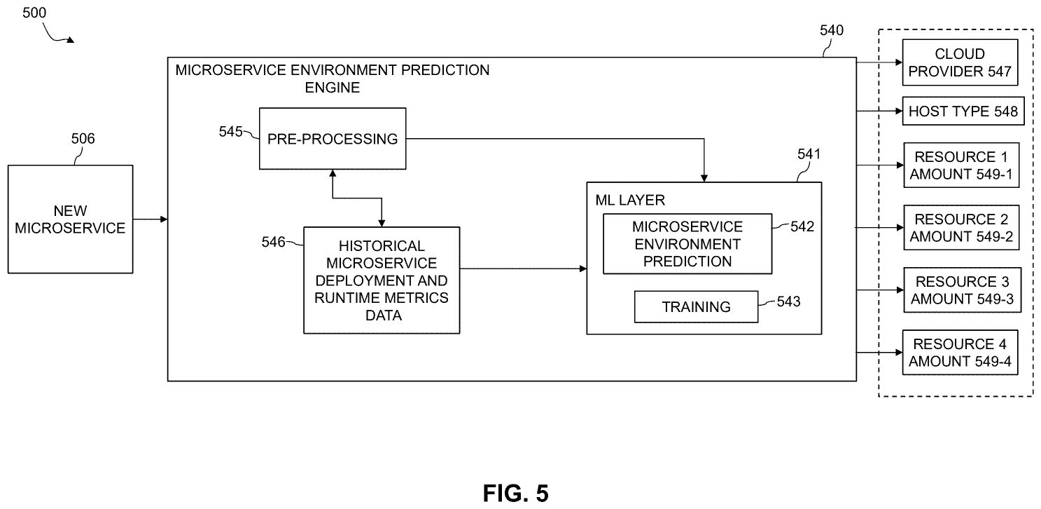

As described in more detail in connection with operational flow 500 in FIG. 5, six targets (e.g., cloud provider 547, host type 548, resource 1 amount 549-1, resource 2 amount 549-2, resource 3 amount 549-3 and resource 4 amount 549-4) are predicted by the microservice environment prediction engine 540 from the same set of input features. In an illustrative embodiment, resource 1 amount 549-1, resource 2 amount 549-2, resource 3 amount 549-3 and resource 4 amount 549-4 (collectively “resource amounts 549”) include CPU utilization, memory utilization, disk I/O utilization, and storage utilization, but the embodiments are not necessarily limited thereto. Cloud provider 547 and host type 548 (e.g., cloud instance) are predicted using a classification approach, and the resource amounts are predicted using a regression mechanism.

In more detail, referring to the operational flow 500 in FIG. 5, the microservice environment prediction engine 540 may be the same as or similar to the microservice environment prediction engine 140. A new microservice request 506 (e.g., request for microservice deployment) the same as or similar to a request for microservice deployment described in connection with FIGS. 1 and 2 is received from, for example, a microservice deployment workflow engine 120 and input to the microservice environment prediction engine 540. The microservice environment prediction engine 540 illustrates a pre-processing component 545, which processes the incoming request and the historical microservice deployment and runtime metrics data 546 for analysis by the machine learning (ML) layer 541. For example, the pre-processing component 545 removes any unwanted characters, punctuation, and stop words. The pre-processing component 545 performs data engineering and data pre-processing to isolate features and data elements that will be influencing the machine learning algorithm and predictions. In illustrative embodiments, the data engineering and data pre-processing includes encoding of categorical and textual attributes. In some embodiments, the data engineering and data pre-processing may include generation of multivariate plots and/or correlation heatmaps to identify the significance of each feature in the dataset so that less important data elements are filtered (e.g., removed or assigned less weight). As a result, the dimensions and complexity of the model are reduced, hence improving accuracy and performance of the model.

As can be seen in FIG. 5, the microservice environment prediction engine 540 predicts cloud provider 547 (e.g., AWS, Azure, GCP, etc.), host type 548 and the various resource amounts 549 for configuring a host type 548 (e.g., cloud instance such as a container, VM, bare metal host, serverless model or other virtual instance) to execute/run a microservice that is the subject of the new microservice request 506. As noted herein, the resource amounts 549 include, but are not necessarily limited to, CPU utilization (e.g., number of CPU cores (millicores)), memory utilization (mebibytes (MiB)) (e.g., RAM and/or ephemeral storage) disk input-output (I/O) utilization (MiB/s) and storage utilization (GB) for data, etc. Disk I/O comprises, for example, read, write and other I/O operations corresponding to a physical disk. Disk I/O may include measurements of active disc I/O time including, for example, the rate at which data is transferred from a hard drive to the RAM. The predictions are performed using the ML layer 541 comprising a microservice environment prediction layer 542 and a training layer 543. The ML layer 541 is the same as or similar to machine learning layer 141. In illustrative embodiments, the microservice environment prediction layer 542 determines, based on training data comprising the historical microservice deployment and runtime metrics data 546 collected by the cloud provider deployment and monitoring engine 150, a host type 548 (e.g., cloud instance), a cloud provider 547 to host the cloud instance, and resource amounts 549 for a cloud instance in which a microservice will be executed. The cloud instance (e.g., host type 548) can comprise, for example, a container, VM, bare metal host, serverless model or other virtual instance.

In an illustrative embodiment, as described in more detail herein, the ML layer 541 utilizes a multi-output neural network comprising a deep neural network that has six parallel branches corresponding to the six outputs 547, 548, 549-1, 549-2, 549-3 and 549-4. By taking the same set of input variables as a single input layer and building a dense multi-layer neural network, ML layer 541 functions as a sophisticated parallel classifier and regressor for multi-output predictions.

The training data input to the training layer 143/543 (e.g., the historical microservice deployment and runtime metrics data 546) includes microservice features as well as runtime metrics of the microservices as described in connection with table 400 in FIG. 4. The microservice environment prediction engine 140/540 utilizes a deep neural network by building a dense, multi-layer neural network to act as a sophisticated classifier and regressors. The machine learning layer 141/541 utilizes a multi-output neural network, which is a deep neural network that has six parallel branches for six types of outputs. By taking the same set of input variables as a single input layer and building a dense, multi-layer neural network this component functions as a network with two classifiers and four regressors for multi-output predictions. The neural network comprises an input layer, one or more hidden layers and an output layer. As a multi-output neural network, six separate branches of the network are generated where each branch includes 2 hidden layers and an output layer that connects to the same (universal) input layer. The input layer includes a number of neurons that matches the number of input/independent variables (e.g., input features). In an illustrative embodiment, each branch includes two hidden layers and the number of neurons in each hidden layer depends upon the number of neurons in the input layer. The output layer for each branch may include different numbers of neurons depending upon the type of output needed. In this situation, for the first two branches of the network, which are classifiers and used for predicting the cloud provider type and host type, the output layer includes, for example, five neurons for cloud providers (or more or less depending upon the number of types of cloud providers), four neurons for host type (or more or less depending upon the number of types of host types) and a softmax activation function. The respective output layers for the remaining four branches, which are designed to be regressors and to predict the configuration of a cloud instance (e.g., compute, memory, disk I/O utilization and storage amounts), will include one neuron with a linear or no activation function. The neurons in the hidden layers use a rectified linear unit (ReLu) activation function for all 4 branches.

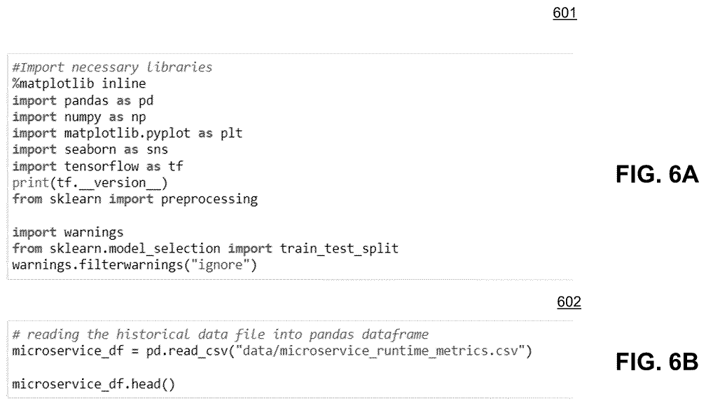

In connection with the operation of the microservice environment prediction engine 140, FIG. 6A depicts example pseudocode 601 for importation of libraries used to implement the microservice environment prediction engine 140. For example, Tensorflow®, Keras, Python, ScikitLearn, Pandas and/or Numpy libraries can be used. Data pre-processing is performed by the pre-processing component 545 and/or the microservice data and metadata repository 160 to identify important features of the historical deployment and/or runtime metrics data and metadata. In more detail, a training dataset is read and a data frame (e.g., Pandas data frame) corresponding to the training dataset is generated. The data frame comprises a plurality of partitioned independent variables (e.g., partitioned in columns) representing the input features (e.g., code size, code language, complexity, interactivity, cold start time, execution time, etc.) and the dependent/target variable columns (cloud provider, host type, CPU utilization, memory utilization, disk I/O utilization, storage utilization). An initial step is to pre-process the data to address any null or missing values in the partitions (e.g., columns). Null and/or missing values in partitions with numerical data can be replaced by the median value of that partition or other average value (e.g., mean). After generating univariate and/or bivariate plots of the partitions, the importance and influence of each partition is determined. Partitions that have little or no role or influence on the actual prediction (target variables) can be dropped. In other words, one or more of a plurality of partitioned independent variables are identified to be removed from the training dataset based at least in part on whether the one or more of the plurality of partitioned independent variables factor into the prediction of the cloud provider, host type, CPU utilization, memory utilization and/or disk I/O utilization. The identified one or more of the plurality of partitioned independent variables are removed from the training dataset, and the machine learning model is trained with the modified training dataset.

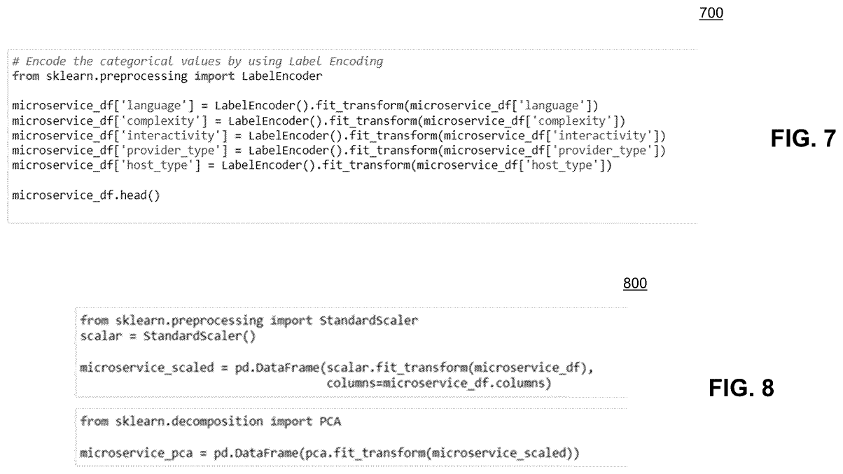

FIG. 6B depicts example pseudocode 602 for loading the historical deployment data and metadata in the form of microservice runtime metrics into a Pandas data frame for building the training data. The data may be in the form of a CSV file. Since machine learning works with vectors (e.g., numbers), categorical and textual attributes like code language, complexity tier, interactivity, cloud provider, host type, etc. must be encoded before being used as training data. In one or more embodiments, this can be achieved by leveraging a LabelEncoder function of ScikitLearn library as shown in the pseudocode 700 in FIG. 7.

A further step in the process is to reduce the dimensionality of the dataset by applying principal component analysis (PCA). Prior to PCA, the dataset needs to be normalized by applying scaling. This can be achieved by using a StandardScaler function available in ScikitLearn library. After normalization, the data can be passed to a PCA function for dimensionality reduction and made ready for model training. FIG. 8 depicts example pseudocode 800 for normalizing and reducing dimensionality of a dataset.

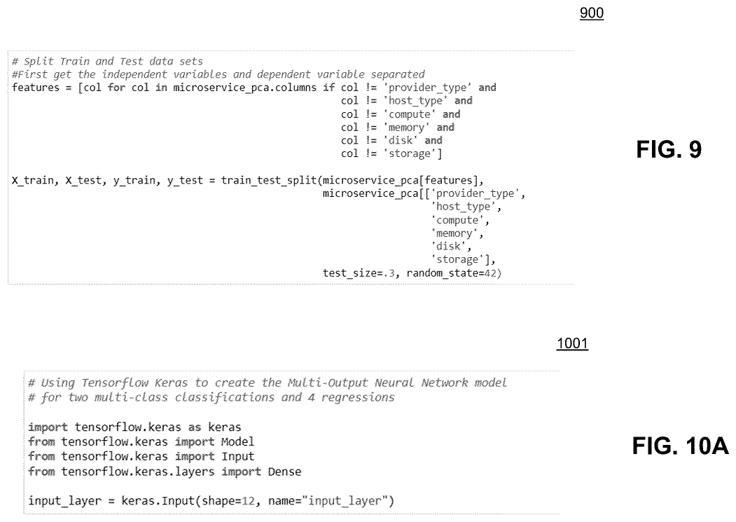

According to illustrative embodiments, the encoded training dataset is split into training and testing datasets, and separate datasets are created for independent variables and dependent variables. FIG. 9 depicts example pseudocode 900 for splitting a dataset into training and testing components and for creating separate datasets for independent (X) and dependent (y) variables. The dataset is split into training and testing datasets using train_test_split function of ScikitLearn library with, for example, a 70%-30% split. Considering this is a multi-output prediction with both multi-class classification and regression use cases, and a dense neural network will be used as the model, it is important to scale the data before passing the data to the model. Since scaling is already done before PCA, there is no need to scale the data again. At the end of these activities, the data is ready for model training and testing.

Once the datasets are ready for training and testing, a multi-layer, multi-output capable dense neural network is created using a Keras library. The neural network is built using a Keras functional model, with six separate branches being created and added to the functional model. Two separate dense layers are added to the input layer with each branch predicting different targets (e.g., cloud provider, host type, CPU utilization, memory utilization, disk I/O utilization and storage utilization).

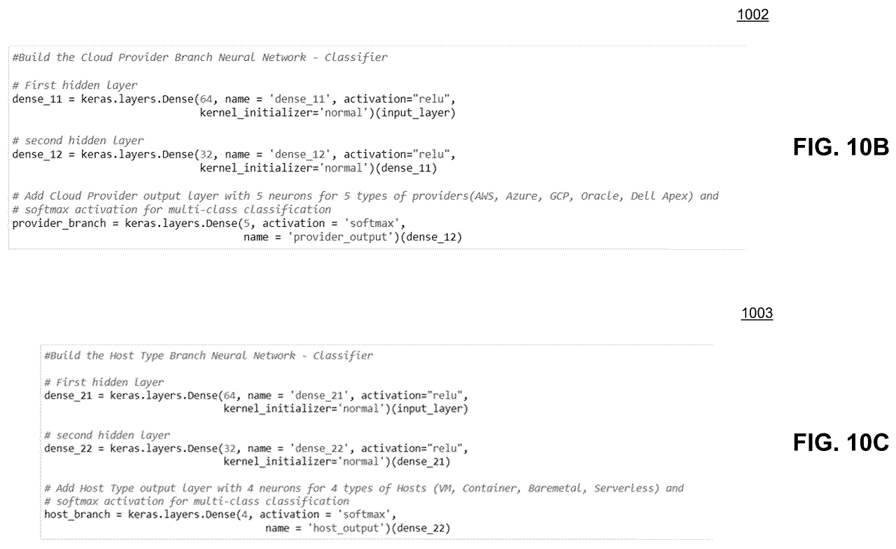

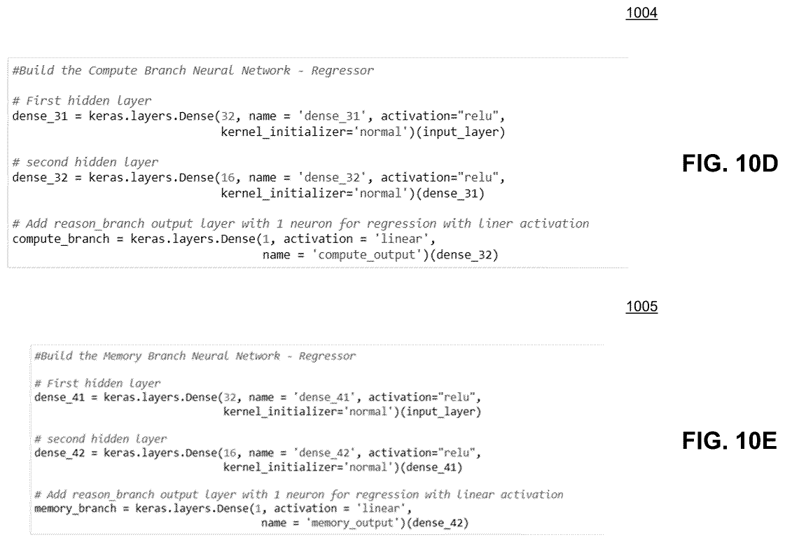

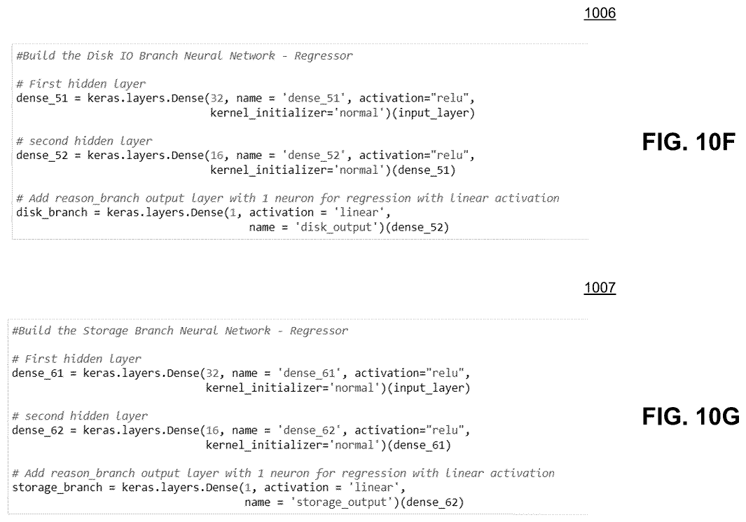

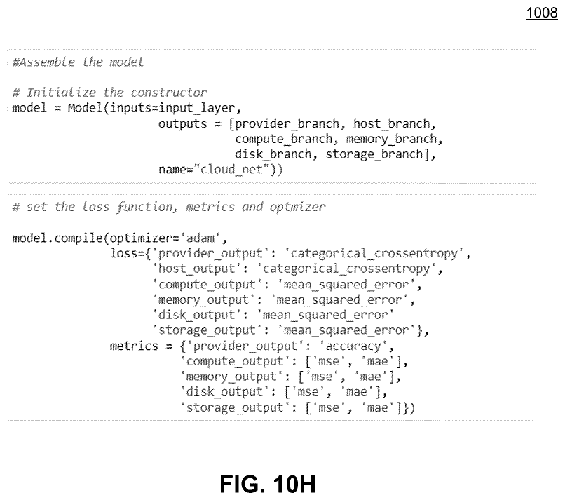

FIG. 10A depicts example pseudocode 1001 for using a designated library to build the neural network. For example, Tensorflow® and Keras libraries are used. The input layer is created with 12 neurons and then six parallel branches are created from the same input layer.

FIG. 10B depicts example pseudocode 1002 for building a cloud provider branch of the neural network. In this case, the cloud provider branch has five neurons for five types of cloud providers and uses a softmax activation function for multi-class classification. FIG. 10C depicts example pseudocode 1003 for building a host type branch of the neural network. In this case, the host type branch has four neurons for four types of host types and uses a softmax activation function for multi-class classification. FIG. 10D depicts example pseudocode 1004 for building a compute utilization branch of the neural network. FIG. 10E depicts example pseudocode 1005 for building the memory utilization branch of the neural network. FIG. 10F depicts example pseudocode 1006 for building the disk I/O value branch of the neural network. FIG. 10G depicts example pseudocode 1007 for building the storage value branch of the neural network. Each of these parallel branches includes one neuron for regression with linear activation.

The input layer is created with 12 neurons and then six parallel branches are created from the same input layer. Each of these parallel branches have two hidden layers with 64 neurons in the first layer and 32 in the second layer for the first two branches and 32 neurons on the first layer and 16 in the second layer for the remaining four branches. The hidden layers use ReLu as the activation function. Once the branches are created, they are assembled into the main model.

FIG. 10H depicts example pseudocode 1008 for assembling the neural network and setting a loss function, metrics and an optimizer of a neural network. Referring to the pseudocode 1008, using a model function, the functional model including the cloud provider branch, host type branch, compute utilization branch, memory utilization branch, disk I/O value branch and storage utilization branch is created. Once the model is created, loss function, optimizer type and validation metrics are added to the model using a compile function. As noted herein above, “categorical_crossentropy” and “mean_squared error” are used as the loss functions, adam is used as the optimizer and “accuracy,” “mse” and “mae” are used as validation metrics.

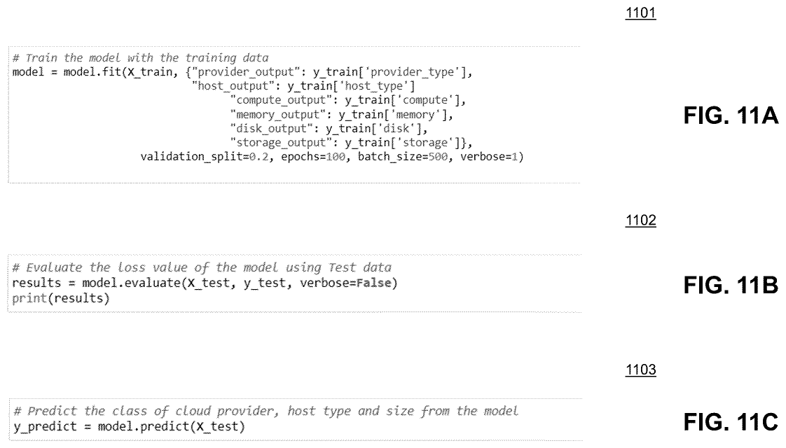

Referring to the pseudocode 1101 for training a neural network model in FIG. 11A, neural network model training can be achieved by calling a fit( ) function of the model and passing training data through the neural network for a designated number of epochs. After the model completes a designated number of epochs, the model is trained and ready for validation. Referring to the pseudocode 1102 for evaluating a loss value of a neural network model in FIG. 11B, a loss/error value can be obtained by calling an evaluate( ) function of the model and passing test data through the neural network. The loss value indicates how well the model is trained. A higher loss value means the model is not trained enough, so hyperparameter tuning is required. The number of epochs can be increased to train the model more. Other hyperparameter tuning can be done by changing the loss function, optimizer algorithm and/or making changes to the neural network architecture by adding more hidden layers. Once the model is fully trained with a reasonable value of loss (as close to 0 as possible), the model is ready for prediction. Referring to the pseudocode 1103 for predicting cloud provider, host type and cloud instance configuration, prediction of the model is achieved by calling a predict( ) function of the model and passing the independent variables of test data through the neural network (for comparing training vs test data) or passing the real values through neural network to predict a cloud provider and cloud instance configuration (target variables).

Referring back to the operational flow 200 in FIG. 2, when users and/or applications request to deploy a microservice 203, the microservice deployment workflow engine 120 sends a call to the cloud deployment state engine 130 to verify whether the function has been previously deployed. If the function was not previously deployed, the microservice deployment workflow engine 120 sends a call to the microservice environment prediction engine 140 to predict an environment in which to deploy the microservice. Following the prediction, the microservice deployment workflow engine 120 sends code associated with the microservice and data and metadata corresponding to the predicted environment (e.g., one of cloud provider platforms 105-1, 105-2, 105-3 or 105-4, host type and resource amounts) to the cloud provider deployment and monitoring engine 150. The cloud provider deployment and monitoring engine 150 generates one or more APIs based at least in part on the code of the microservice and data and/or metadata corresponding to the predicted cloud provider platform 105, host type and resource amounts. The cloud provider deployment and monitoring engine 150 invokes the one or more APIs to communicate the request for cloud deployment of the microservice to the predicted cloud provider platform 105.

In illustrative embodiments, once deployed, the microservice deployment workflow engine 120 updates the cloud deployment state engine 130 with a digest of the microservice, the utilized cloud provider platform 105, the utilized cloud instance (e.g., host type) and cloud instance configuration data. Data and metadata corresponding to the code and features of the microservice and the corresponding cloud provider platform 105, cloud instance and cloud instance configuration are persisted in the microservice data and metadata repository 160 for future training of the machine learning models used by the microservice environment prediction engine 140. In addition, runtime metrics corresponding to the deployment of microservices from the cloud provider platforms 105 are captured from the cloud provider platforms 105 by the cloud provider deployment and monitoring engine 150 on a periodic basis. As explained in more detail herein, such capturing of runtime metrics can be achieved by calling appropriate software development kits (SDKs) and APIs (for example boto3 in AWS). The runtime metrics data and metadata is stored in the microservice data and metadata repository 160 for future training of the machine learning models used by the microservice environment prediction engine 140.

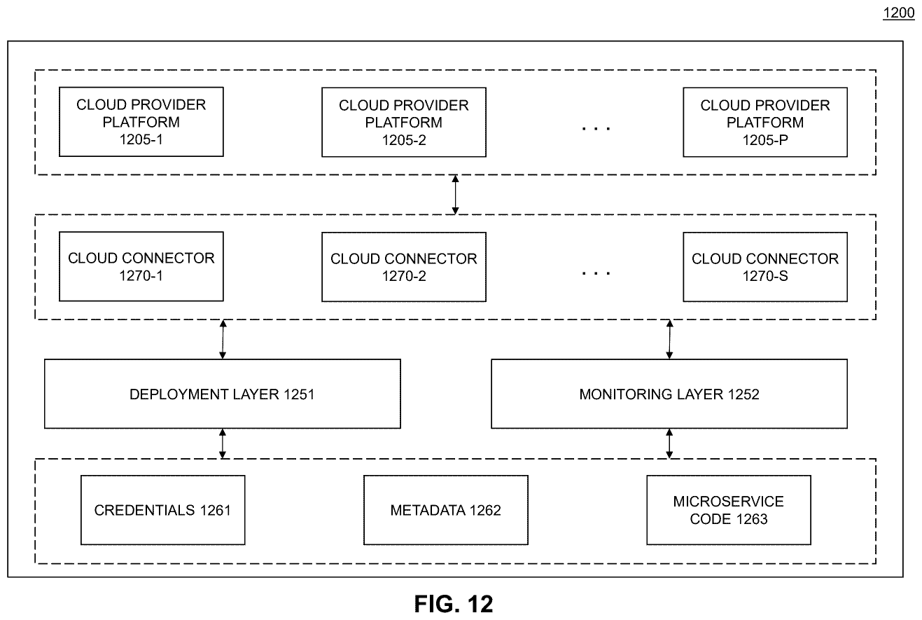

Referring to the operational diagram 1200 in FIG. 12, the deployment layer 1251, which is the same or similar to the deployment layer 151 of the cloud provider deployment and monitoring engine 150, functions as an abstraction layer for various cloud providers and hides the complexities of interfacing with microservice deployments from requesters of microservice deployments. The deployment layer 1251 interfaces with the cloud provider platforms 1205-1, 1205-2, . . . 1205-P (collectively “cloud provider platforms 1205”) via one or more cloud connectors 1270-1, 1270-2, . . . 1270-S (collectively “cloud connectors 1270”). The cloud provider platforms 1205 may be the same as or similar to the cloud provider platforms 105. As different cloud provider platforms 1205 use different APIs and metadata types, the deployment layer 1251 creates the appropriate interfaces, data types and calls the necessary APIs of the cloud provider platform 1205 on which a microservice is to be deployed to receive the runtime metrics like CPU, memory, disk I/O utilization and storage utilization of each deployed microservice.

While some of the metadata 1262 may be unique to particular cloud provider platforms 1205, other metadata 1262 may be universal to the cloud provider platforms 1205. For example, information like microservice code 1263, function_name, description, run_time (e.g., python 3.10), deployment region, etc., can be the same across different cloud provider platforms 1205. Some information may be specific to a cloud provider platform 1205, such as, for example, identity credentials (e.g., credentials 1261), storage locations (e.g., S3 bucket), etc.

The monitoring layer 1252, which is the same or similar to the monitoring layer 152 of the cloud provider deployment and monitoring engine 150, monitors the existing (e.g., already deployed) microservices and their corresponding cloud instances in a multi-cloud environment. The monitoring layer 1252 connects to the cloud provider platforms 1205 via one or more cloud connectors 1270. The cloud provider deployment and monitoring engine 150 creates custom cloud connectors 1270 using the credentials 1261 and APIs for each cloud provider platform 1205 and uses the cloud connectors 1270 for deployment and monitoring. The monitoring layer 1252 captures runtime metrics of the deployed microservices, which can be used as further training data for the machine learning models in the microservice environment prediction engine 140.

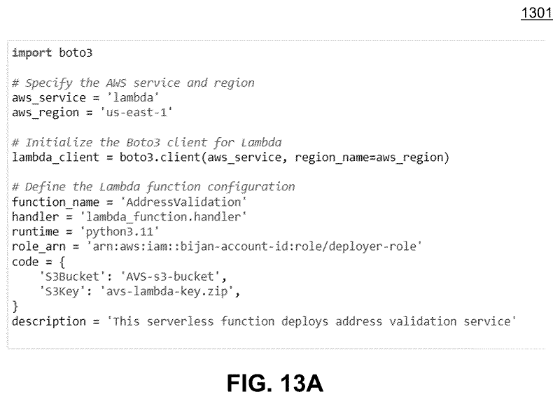

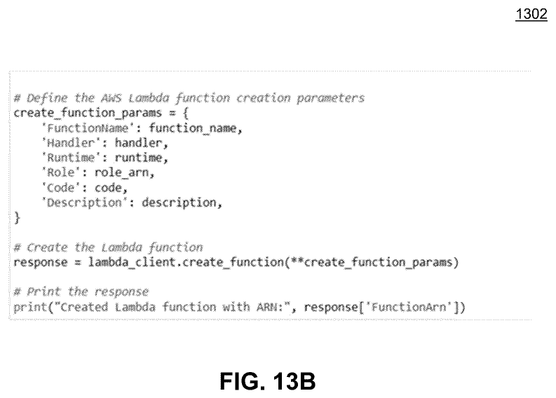

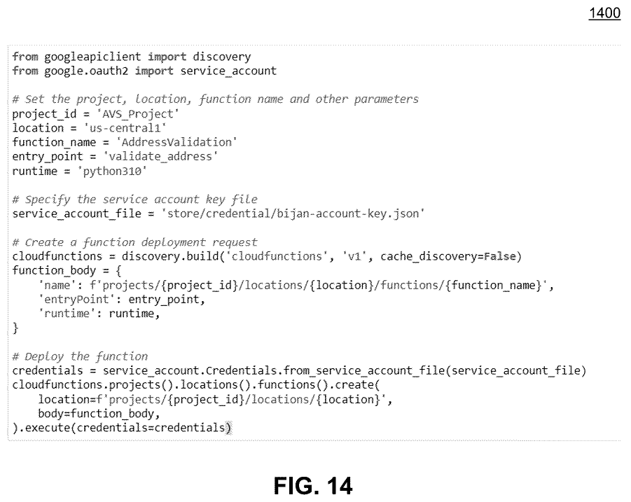

As part of the deployment of microservices in different host types (e.g., cloud instances) like VMs, containers, serverless models and bare metal hosts, the deployment layer 1251 uses specific APIs and libraries to connect to the cloud provider platforms 1205. In more detail, the cloud provider deployment and monitoring engine 150 leverages the microservice code 1263 and associated metadata 1262 to build the payload for the appropriate API of the predicted cloud provider platform 105/1205. Pseudocode 1301 and 1302 for deploying a microservice as a serverless function using boto3 libraries in AWS® is shown in FIGS. 13A and 13B. Pseudocode 1400 for deploying a microservice as a serverless function in a Google® cloud platform using its API is shown in FIG. 14.

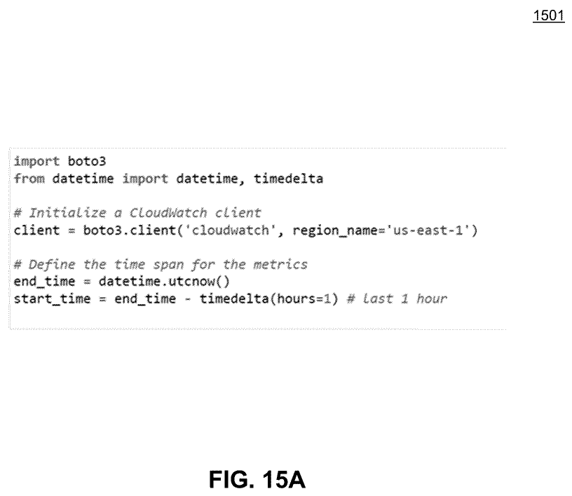

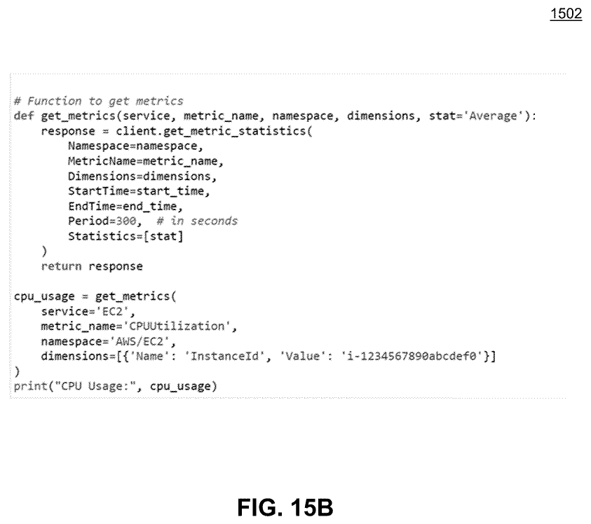

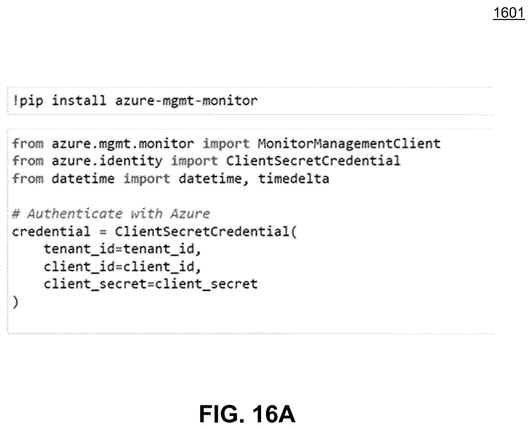

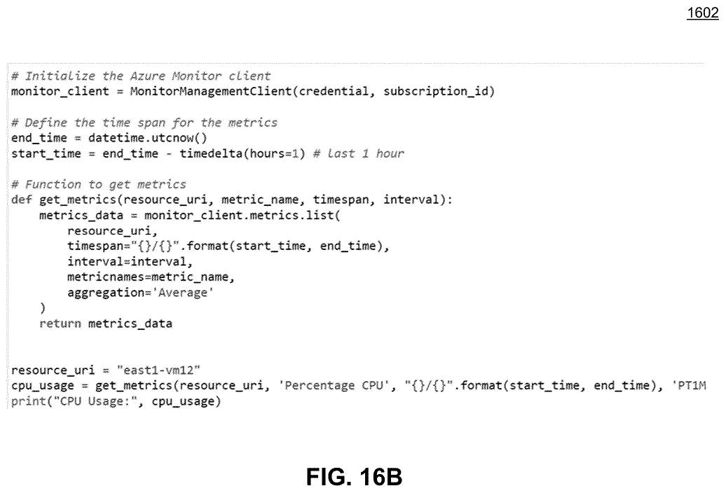

In illustrative embodiments, the metrics of microservices can be obtained by the monitoring layer 152/1252 by calling appropriate services in a public cloud. For example, AWS® Lambda® microservice metrics can be obtained from a CloudWatch® service and the boto3 client API can be used to call the CloudWatch® managed service and return the metrics. FIGS. 15A and 15B depict sample pseudocode 1501 and 1502 that return average CPU utilization and other metrics data from CloudWatch®. Referring to the pseudocode 1601 and 1602 in FIGS. 16A and 16B, in the case of Azure®, an Azure® management monitor client library of Python can be used to access metrics, such as, for example, CPU utilization.

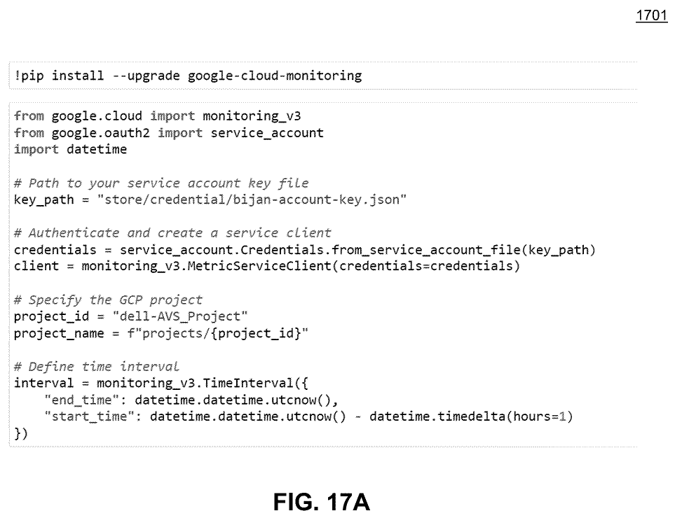

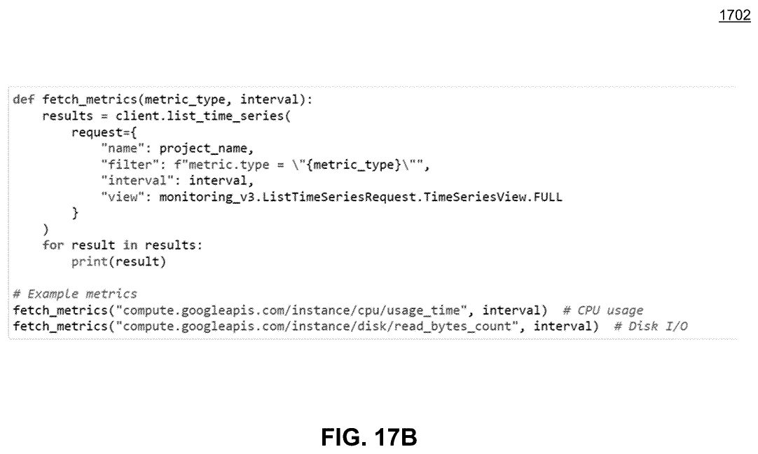

FIGS. 17A and 17B depict example pseudocode 1701 and 1702 for retrieving microservice metrics, such as, for example, CPU utilization and disk I/O utilization from a Google® cloud platform.

In some embodiments, the microservice data and metadata repository 160, storage layer 132 and other data corpuses, repositories or databases referred to herein are implemented using one or more storage systems or devices associated with the microservices deployment platform 110. In some embodiments, one or more of the storage systems utilized to implement the microservice data and metadata repository 160, storage layer 132 and other data corpuses, repositories or databases referred to herein comprise a scale-out all-flash content addressable storage array or other type of storage array.

The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although shown as elements of the microservices deployment platform 110, the microservice deployment workflow engine 120, cloud deployment state engine 130, microservice environment prediction engine 140, cloud provider deployment and monitoring engine 150 and/or microservice data and metadata repository 160 in other embodiments can be implemented at least in part externally to the microservices deployment platform 110, for example, as stand-alone servers, sets of servers or other types of systems coupled to the network 104. For example, the microservice deployment workflow engine 120, cloud deployment state engine 130, microservice environment prediction engine 140, cloud provider deployment and monitoring engine 150 and/or microservice data and metadata repository 160 may be provided as cloud services accessible by the microservices deployment platform 110.

The microservice deployment workflow engine 120, cloud deployment state engine 130, microservice environment prediction engine 140, cloud provider deployment and monitoring engine 150 and/or microservice data and metadata repository 160 in the FIG. 1 embodiment are each assumed to be implemented using at least one processing device. Each such processing device generally comprises at least one processor and an associated memory, and implements one or more functional modules for controlling certain features of the microservice deployment workflow engine 120, cloud deployment state engine 130, microservice environment prediction engine 140, cloud provider deployment and monitoring engine 150 and/or microservice data and metadata repository 160.

At least portions of the microservices deployment platform 110 and the elements thereof may be implemented at least in part in the form of software that is stored in memory and executed by a processor. The microservices deployment platform 110 and the elements thereof comprise further hardware and software required for running the microservices deployment platform 110, including, but not necessarily limited to, on-premises or cloud-based centralized hardware, graphics processing unit (GPU) hardware, virtualization infrastructure software and hardware, Docker containers, networking software and hardware, and cloud infrastructure software and hardware.

Although the microservice deployment workflow engine 120, cloud deployment state engine 130, microservice environment prediction engine 140, cloud provider deployment and monitoring engine 150, microservice data and metadata repository 160 and other elements of the microservices deployment platform 110 in the present embodiment are shown as part of the microservices deployment platform 110, at least a portion of the microservice deployment workflow engine 120, cloud deployment state engine 130, microservice environment prediction engine 140, cloud provider deployment and monitoring engine 150, microservice data and metadata repository 160 and other elements of the microservices deployment platform 110 in other embodiments may be implemented on one or more other processing platforms that are accessible to the microservices deployment platform 110 over one or more networks. Such elements can each be implemented at least in part within another system element or at least in part utilizing one or more stand-alone elements coupled to the network 104.

It is assumed that the microservices deployment platform 110 in the FIG. 1 embodiment and other processing platforms referred to herein are each implemented using a plurality of processing devices each having a processor coupled to a memory. Such processing devices can illustratively include particular arrangements of compute, storage and network resources. For example, processing devices in some embodiments are implemented at least in part utilizing virtual resources such as virtual machines (VMs) or LXCs, or combinations of both as in an arrangement in which Docker containers or other types of LXCs are configured to run on VMs.

The term “processing platform” as used herein is intended to be broadly construed so as to encompass, by way of illustration and without limitation, multiple sets of processing devices and one or more associated storage systems that are configured to communicate over one or more networks.

As a more particular example, the microservice deployment workflow engine 120, cloud deployment state engine 130, microservice environment prediction engine 140, cloud provider deployment and monitoring engine 150, microservice data and metadata repository 160 and other elements of the microservices deployment platform 110, and the elements thereof can each be implemented in the form of one or more LXCs running on one or more VMs. Other arrangements of one or more processing devices of a processing platform can be used to implement the microservice deployment workflow engine 120, cloud deployment state engine 130, microservice environment prediction engine 140, cloud provider deployment and monitoring engine 150 and microservice data and metadata repository 160, as well as other elements of the microservices deployment platform 110. Other portions of the system 100 can similarly be implemented using one or more processing devices of at least one processing platform.

Distributed implementations of the system 100 are possible, in which certain elements of the system reside in one data center in a first geographic location while other elements of the system reside in one or more other data centers in one or more other geographic locations that are potentially remote from the first geographic location. Thus, it is possible in some implementations of the system 100 for different portions of the microservices deployment platform 110 to reside in different data centers. Numerous other distributed implementations of the microservices deployment platform 110 are possible.

Accordingly, one or each of the microservice deployment workflow engine 120, cloud deployment state engine 130, microservice environment prediction engine 140, cloud provider deployment and monitoring engine 150, microservice data and metadata repository 160 and other elements of the microservices deployment platform 110 can each be implemented in a distributed manner so as to comprise a plurality of distributed elements implemented on respective ones of a plurality of compute nodes of the microservices deployment platform 110.

It is to be appreciated that these and other features of illustrative embodiments are presented by way of example only, and should not be construed as limiting in any way. Accordingly, different numbers, types and arrangements of system elements such as the microservice deployment workflow engine 120, cloud deployment state engine 130, microservice environment prediction engine 140, cloud provider deployment and monitoring engine 150, microservice data and metadata repository 160 and other elements of the microservices deployment platform 110, and the portions thereof can be used in other embodiments.

It should be understood that the particular sets of modules and other elements implemented in the system 100 as illustrated in FIG. 1 are presented by way of example only. In other embodiments, only subsets of these elements, or additional or alternative sets of elements, may be used, and such elements may exhibit alternative functionality and configurations.

For example, as indicated previously, in some illustrative embodiments, functionality for the microservices deployment platform can be offered to cloud infrastructure customers or other users as part of FaaS, CaaS and/or PaaS offerings.

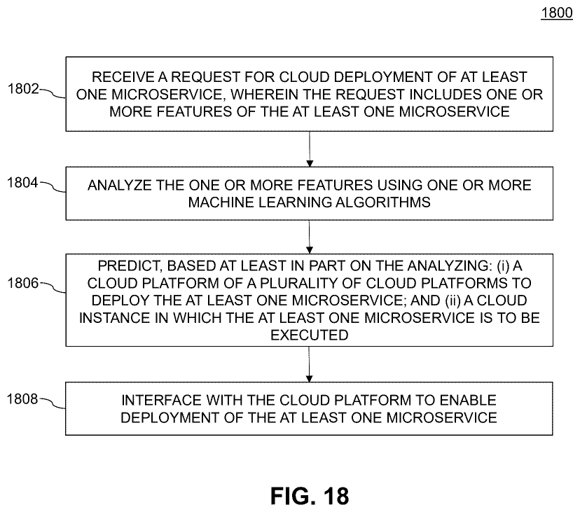

The operation of the information processing system 100 will now be described in further detail with reference to the flow diagram of FIG. 18. With reference to FIG. 18, a process 1800 for cloud deployment of microservices as shown includes steps 1802 through 1808, and is suitable for use in the system 100 but is more generally applicable to other types of information processing systems comprising a microservices deployment platform configured for selecting cloud providers and cloud instances and predicting configurations of cloud instances on which to deploy microservices.

In step 1802, a request for cloud deployment of at least microservice is received. The request includes one or more features of the at least one microservice. The one or more features may identify at least one of a size of code for the at least one microservice, a language of the code for the at least one microservice, a complexity tier of the at least one microservice, an interactivity determination of the at least one microservice, a cold start time of the at least one microservice and an execution time of the at least one microservice.

In step 1804, the one or more features are analyzed using one or more machine learning algorithms. The one or more machine learning algorithms may be trained with historical feature data of a plurality of microservices. The historical feature data may specify for respective ones of the plurality of microservices at least one of: (i) a code size; (ii) a code language; (iii) a complexity tier; (iv) an interactivity determination; (v) a cold start time; and (vi) an execution time.

In step 1806, based at least in part on the analyzing, a cloud platform of a plurality of cloud platforms is predicted to deploy the at least one microservice, and a cloud instance in which the at least one microservice is to be executed is predicted. The cloud instance may comprise at least one of a container, a virtual machine, a bare metal host and a serverless model.

Step 1808 comprises interfacing with the cloud platform to enable deployment of the at least one microservice. The interfacing may comprise generating one or more APIs based at least in part on code of the at least one microservice and metadata corresponding to the cloud platform, and invoking the one or more APIs to communicate the request for deployment of the at least one microservice to the cloud platform.

The process may further comprise predicting, based at least in part on the analyzing, a configuration of the cloud instance in which the at least one microservice is to be executed. The predicting of the cloud platform and the cloud instance can be performed using a classification machine learning algorithm, and the predicting of the configuration of the cloud instance can be performed using a regression machine learning algorithm. The classification and regression machine learning algorithms may analyze same ones of the one or more features.

The one or more machine learning algorithms may comprise a neural network configured to predict a first plurality of targets and a second plurality of targets, wherein the first plurality of targets are predicted using a classification technique, and the second plurality of targets are predicted using a regression technique. The first plurality of targets may comprise the cloud platform and the cloud instance, and the second plurality of targets may comprise respective amounts for CPU utilization, memory utilization, disk I/O utilization and storage utilization in connection with the execution of the at least one microservice in the cloud instance.

In illustrative embodiments, the process may further comprise verifying a deployment history of the at least one microservice. The verifying may comprise determining whether the at least one microservice was previously deployed on the predicted cloud platform using the predicted cloud instance, and if the at least one microservice was previously deployed on the predicted cloud platform using the predicted cloud instance, determining whether code for the at least one microservice is unchanged from the previous deployment.

The process may further comprise generating a unique identifier for the deployment of the at least one microservice, wherein generating the unique identifier comprises using a hash function to generate a hash digest of one or more files corresponding to the deployment of the at least one microservice.

In illustrative embodiments, one or more runtime metrics corresponding to the deployment of the at least one microservice are collected from the cloud platform. The one or more runtime metrics can be used for training the one or more machine learning algorithms.

It is to be appreciated that the FIG. 18 process and other features and functionality described above can be adapted for use with other types of information systems configured to execute microservice deployment services in a microservices deployment platform or other type of platform.

The particular processing operations and other system functionality described in conjunction with the flow diagram of FIG. 18 are therefore presented by way of illustrative example only, and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Functionality such as that described in conjunction with the flow diagram of FIG. 18 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Illustrative embodiments of systems with a microservices deployment platform as disclosed herein can provide a number of significant advantages relative to conventional arrangements. For example, the microservices deployment platform uses machine learning to predict and automatically select cloud providers, cloud instances and configurations of cloud instances for use in connection with deploying different microservices. The embodiments advantageously leverage sophisticated machine learning classification and regression techniques that are trained using multi-dimensional, historical feature data and runtime metrics of a plurality of microservices to predict cloud providers, cloud instances and configurations of cloud instances that are most appropriate for given microservices. Advantageously, the framework predicts the optimal host type/cloud instance and the cloud provider type to enable smart deployment of microservices in a multi-cloud environment.

Unlike conventional approaches, illustrative embodiments provide technical solutions which offer a modular and pluggable microservices deployment framework for multiple microservices requiring heterogenous cloud providers. Advantageously, the framework enables prediction of cloud providers for different microservices and interfacing with the different cloud providers that require different configurations and/or metadata. As an additional advantage, the embodiments provide techniques to monitor and capture runtime metrics of current microservice deployments, and use the captured runtime metrics for additional training of machine learning models being used to predict the cloud providers, cloud instances and configurations of cloud instances for the respective microservices.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As noted above, at least portions of the information processing system 100 may be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform that may be used to implement at least a portion of an information processing system comprise cloud infrastructure including virtual machines and/or container sets implemented using a virtualization infrastructure that runs on a physical infrastructure. The cloud infrastructure further comprises sets of applications running on respective ones of the virtual machines and/or container sets.

These and other types of cloud infrastructure can be used to provide what is also referred to herein as a multi-tenant environment. One or more system elements such as the microservices deployment platform 110 or portions thereof are illustratively implemented for use by tenants of such a multi-tenant environment.

As mentioned previously, cloud infrastructure as disclosed herein can include cloud-based systems. Virtual machines provided in such systems can be used to implement at least portions of one or more of a computer system and a microservices deployment platform in illustrative embodiments. These and other cloud-based systems in illustrative embodiments can include object stores.

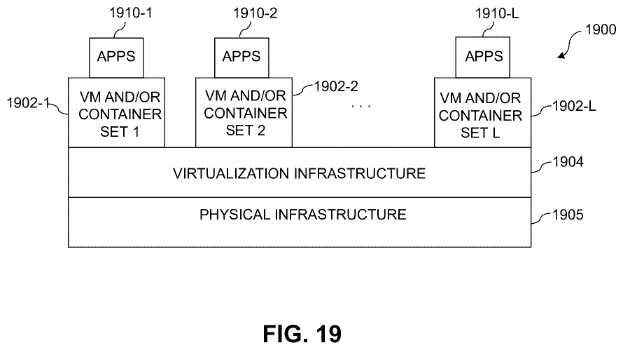

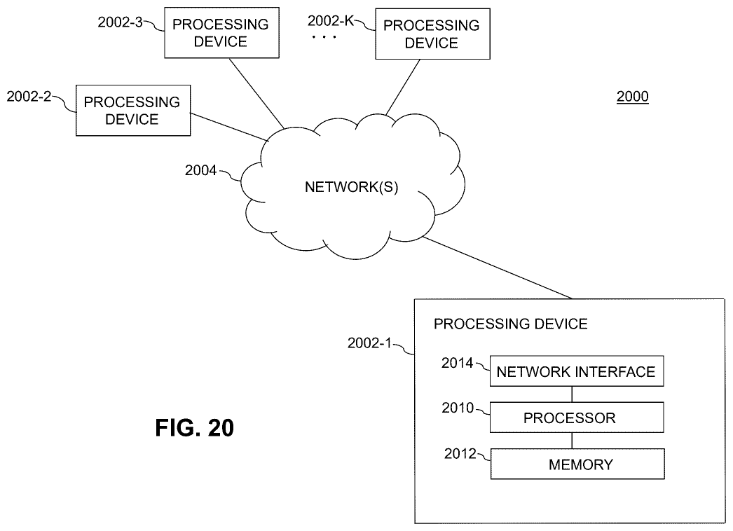

Illustrative embodiments of processing platforms will now be described in greater detail with reference to FIGS. 19 and 20. Although described in the context of system 100, these platforms may also be used to implement at least portions of other information processing systems in other embodiments.

FIG. 19 shows an example processing platform comprising cloud infrastructure 1900. The cloud infrastructure 1900 comprises a combination of physical and virtual processing resources that may be utilized to implement at least a portion of the information processing system 100. The cloud infrastructure 1900 comprises multiple virtual machines (VMs) and/or container sets 1902-1, 1902-2, . . . 1902-L implemented using virtualization infrastructure 1904. The virtualization infrastructure 1904 runs on physical infrastructure 1905, and illustratively comprises one or more hypervisors and/or operating system level virtualization infrastructure. The operating system level virtualization infrastructure illustratively comprises kernel control groups of a Linux operating system or other type of operating system.

The cloud infrastructure 1900 further comprises sets of applications 1910-1, 1910-2, . . . 1910-L running on respective ones of the VMs/container sets 1902-1, 1902-2, . . . 1902-L under the control of the virtualization infrastructure 1904. The VMs/container sets 1902 may comprise respective VMs, respective sets of one or more containers, or respective sets of one or more containers running in VMs.

In some implementations of the FIG. 19 embodiment, the VMs/container sets 1902 comprise respective VMs implemented using virtualization infrastructure 1904 that comprises at least one hypervisor. A hypervisor platform may be used to implement a hypervisor within the virtualization infrastructure 1904, where the hypervisor platform has an associated virtual infrastructure management system. The underlying physical machines may comprise one or more distributed processing platforms that include one or more storage systems.

In other implementations of the FIG. 19 embodiment, the VMs/container sets 1902 comprise respective containers implemented using virtualization infrastructure 1904 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1900 shown in FIG. 19 may represent at least a portion of one processing platform. Another example of such a processing platform is processing platform 2000 shown in FIG. 20.

The processing platform 2000 in this embodiment comprises a portion of system 100 and includes a plurality of processing devices, denoted 2002-1, 2002-2, 2002-3, . . . 2002-K, which communicate with one another over a network 2004.

The network 2004 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 2002-1 in the processing platform 2000 comprises a processor 2010 coupled to a memory 2012. The processor 2010 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 2012 may comprise random access memory (RAM), read-only memory (ROM), flash memory or other types of memory, in any combination. The memory 2012 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 2002-1 is network interface circuitry 2014, which is used to interface the processing device with the network 2004 and other system components, and may comprise conventional transceivers.

The other processing devices 2002 of the processing platform 2000 are assumed to be configured in a manner similar to that shown for processing device 2002-1 in the figure.

Again, the particular processing platform 2000 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality of one or more elements of the microservices deployment platform 110 as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems and microservices deployment platforms. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
receiving a request for cloud deployment of at least one microservice, wherein the request includes one or more features of the at least one microservice;
analyzing the one or more features using one or more machine learning algorithms;
predicting, based at least in part on the analyzing: (i) a cloud platform of a plurality of cloud platforms to deploy the at least one microservice; and (ii) a cloud instance in which the at least one microservice is to be executed; and
interfacing with the cloud platform to enable deployment of the at least one microservice;
wherein the steps of the method are executed by a processing device operatively coupled to a memory.

2. The method of claim 1 further comprising predicting, based at least in part on the analyzing, a configuration of the cloud instance in which the at least one microservice is to be executed.

3. The method of claim 2 wherein:
the predicting of the cloud platform and of the cloud instance is performed using a classification machine learning algorithm;
the predicting of the configuration of the cloud instance is performed using a regression machine learning algorithm; and
the classification and regression machine learning algorithms analyze same ones of the one or more features.

4. The method of claim 1 wherein the cloud instance comprises at least one of a container, a virtual machine, a bare metal host and a serverless model.

5. The method of claim 1 wherein the one or more features identify at least one of a size of code for the at least one microservice, a language of the code for the at least one microservice, a complexity tier of the at least one microservice, an interactivity determination of the at least one microservice, a cold start time of the at least one microservice and an execution time of the at least one microservice.

6. The method of claim 1 wherein:
the one or more machine learning algorithms comprise a neural network configured to predict a first plurality of targets and a second plurality of targets;
the first plurality of targets are predicted using a classification technique; and
the second plurality of targets are predicted using a regression technique.

7. The method of claim 6, wherein the first plurality of targets comprises the cloud platform and the cloud instance, and the second plurality of targets comprise respective amounts for central processing unit utilization, memory utilization, disk input-output utilization and storage utilization in connection with the execution of the at least one microservice in the cloud instance.

8. The method of claim 1 further comprising training the one or more machine learning algorithms with historical feature data of a plurality of microservices.

9. The method of claim 8, wherein the historical feature data specifies for respective ones of the plurality of microservices at least one of: (i) a code size; (ii) a code language; (iii) a complexity tier; (iv) an interactivity determination; (v) a cold start time; and (vi) an execution time.

10. The method of claim 1 further comprising verifying a deployment history of the at least one microservice.

11. The method of claim 10 wherein the verifying comprises:
determining whether the at least one microservice was previously deployed on the predicted cloud platform using the predicted cloud instance; and
if the at least one microservice was previously deployed on the predicted cloud platform using the predicted cloud instance, determining whether code for the at least one microservice is unchanged from the previous deployment.

12. The method of claim 1 further comprising generating a unique identifier for the deployment of the at least one microservice, wherein generating the unique identifier comprises using a hash function to generate a hash digest of one or more files corresponding to the deployment of the at least one microservice.

13. The method of claim 1 wherein the interfacing comprises:
generating one or more application programming interfaces based at least in part on code of the at least one microservice and metadata corresponding to the cloud platform; and
invoking the one or more application programming interfaces to communicate the request for deployment of the at least one microservice to the cloud platform.

14. The method of claim 1 further comprising collecting one or more runtime metrics corresponding to the deployment of the at least one microservice from the cloud platform.

15. The method of claim 14 wherein the one or more runtime metrics are used for training the one or more machine learning algorithms.

16. An apparatus comprising:
a processing device operatively coupled to a memory and configured:
to receive a request for cloud deployment of at least one microservice, wherein the request includes one or more features of the at least one microservice;
to analyze the one or more features using one or more machine learning algorithms;
to predict, based at least in part on the analyzing: (i) a cloud platform of a plurality of cloud platforms to deploy the at least one microservice; and (ii) a cloud instance in which the at least one microservice is to be executed; and
to interface with the cloud platform to enable deployment of the at least one microservice.

17. The apparatus of claim 16 wherein the processing device is further configured to predict, based at least in part on the analyzing, a configuration of the cloud instance in which the at least one microservice is to be executed.

18. The apparatus of claim 17 wherein:
the predicting of the cloud platform and the cloud instance is performed using a classification machine learning algorithm;
the predicting of the configuration of the cloud instance is performed using a regression machine learning algorithm; and
the classification and regression machine learning algorithms analyze same ones of the one or more features.

19. An article of manufacture comprising a non-transitory processor-readable storage medium having stored therein program code of one or more software programs, wherein the program code when executed by at least one processing device causes said at least one processing device to perform the steps of:
receiving a request for cloud deployment of at least one microservice, wherein the request includes one or more features of the at least one microservice;
analyzing the one or more features using one or more machine learning algorithms;
predicting, based at least in part on the analyzing: (i) a cloud platform of a plurality of cloud platforms to deploy the at least one microservice; and (ii) a cloud instance in which the at least one microservice is to be executed; and
interfacing with the cloud platform to enable deployment of the at least one microservice.

20. The article of manufacture of claim 19 wherein the program code further causes said at least one processing device to perform the step of predicting, based at least in part on the analyzing, a configuration of the cloud instance in which the at least one microservice is to be executed.
